(19) United States
(12) Patent Application Publication
(10) Pub. No.: US 2025/0103780 A1
(43) Pub. Date: Mar. 27, 2025

(54) METHOD FOR EVALUATING RUNNING STATE OF BRIDGE USING FINITE ELEMENT PILOT-BASED DEEP LEARNING PROXY MODEL

(71) Applicants: SHENZHEN URBAN TRANSPORT PLANNING CENTER CO., LTD., SHENZHEN (CN); SHENZHEN TRANSPORT SCIENCE RESEARCH INSTITUTE CO., LTD., SHENZHEN (CN)

(72) Inventors: XIAOCHUN ZHANG, SHENZHEN (CN); TAO LIN, SHENZHEN (CN); XING LIU, SHENZHEN (CN); ANXIN MENG, SHENZHEN (CN); ZIYI ZHOU, SHENZHEN (CN); ZHENWU CHEN, SHENZHEN (CN); LEI JIA, SHENZHEN (CN); LU GUO, SHENZHEN (CN)

(21) Appl. No.: 18/950,201

(22) Filed: Nov. 18, 2024

Related U.S. Application Data
(63) Continuation of application No. PCT/CN2024/111193, filed on Aug. 9, 2024.

(30) Foreign Application Priority Data
Sep. 25, 2023 (CN) 202311237009.X

(51) Int. Cl. G06F 30/27; G06F 30/23; G06F 119/14

(52) U.S. Cl. CPC G06F 30/27; G06F 30/23; G06F 2119/14

(57) ABSTRACT

This application provides a method for evaluating a running state of a bridge using a finite element pilot-based deep learning proxy model, belonging to the field of online simulation technologies of bridge structures. The method includes: S1:establishing a finite element simulation model; S2: obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information; S3: adaptively training a finite element pilot-based deep learning neural network proxy model; and S4: inputting the vehicle-environment load information into a finite element pilot-based deep learning neural network proxy model, and outputting a real-time structural state of running of the bridge.

### TECHNICAL FIELD

This application relates to a method for evaluating running and structural states of a bridge, and in particular to a method for evaluating a running state of a bridge using a finite element pilot-based deep learning proxy model, belonging to the field of online simulation technologies of bridge structures.

### BACKGROUND

As a number of bridges keeps increasing and traffic keeps growing, operation, maintenance, and supervision of the bridges become increasingly important over time. How to ensure running safety of the bridges is a field that requires research and exploration in the future. In fact, the bridges as well as other traffic facilities such as tunnels and side slopes are faced with such problems. Safety monitoring of bridge facilities in operating periods is a very important field. Certain developments have been made in the field in recent years. However, current technologies still remain at levels of alarm for monitoring thresholds and trend analysis. In addition, a simulation model of a bridge in an operating period is also only established in a design phase of a monitoring solution, and can only simulate a single existing condition. How to implement real-time online simulation of a bridge structure is a priority research direction.

A researcher has proposed a deep learning-based optimized finite element iteration process method and apparatus, CN114021414B. In the method, prediction of a next state point in iteration is implemented by using a deep learning algorithm, so that a number of iteration steps is reduced, calculation efficiency and convergence of a finite element model are optimized on the basis of ensuring accuracy of simulation results, and high universality is provided. However, the method is based on a data-driven deep learning network and requires manual preparation of a large amount of data for training a model, which consumes a lot of time. Without input of data and understanding of a data relationship, a trained model has poor reliability. In addition, running and structural states of the bridge in the operating period are not evaluated.

### SUMMARY

A brief overview of this application is given below in order to provide a basic understanding of some aspects of this application. It should be understood that this overview is not an exhaustive overview of this application. It is neither intended to identify key or important parts of this application nor intended to limit the scope of this application. The purpose is simply to give some concepts in a simplified form as a prelude to the more detailed descriptions to be discussed later.

In view of the above, to resolve the technical problems that exist in the existing technology, this application provides a method for evaluating a running state of a bridge using a finite element pilot-based deep learning proxy model. Compared with pure data-driven neural network learning, in this application, a physical information constraint is applied in a training process of a PINN, and therefore, a model with a better generalization capability can be learned by using fewer data samples. Compared with conventional network learning, a finite element pilot-based neural network can autonomously complete model training through physical guidance. The problems of time-consuming simulation and low simulation efficiency of a finite element model can be resolved, and real-time simulation of a bridge is implemented, thereby evaluating running and structural states of the bridge.

Solution 1: A method for evaluating a running state of a bridge using a finite element pilot-based deep learning proxy model includes the following steps:
S1: establishing a finite element simulation model;
S2: obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information;
S3: adaptively training a finite element pilot-based deep learning neural network proxy model; and
S4: inputting the vehicle-environment load information into the finite element pilot-based deep learning neural network proxy model, calculating data through the model, and outputting a real-time structural state of running of the bridge.

In some embodiments, a method for establishing a finite element simulation model is as follows:
S11: acquiring bridge structure sizes and material type parameters on a bridge design drawing; and
S12: establishing a bridge finite element model including structural geometry and material information by using a finite element method,

$$Π = \frac{1}{2} {u}^{T} {\int }_{0}^{L} {EIB}^{T} B dx u - {u}^{T} {\int }_{0}^{L} {N}^{T} q dx ,$$

where u is a structural response displacement parameter, u^{T} is a transpose of the structural response displacement parameter, E is a structural elastic modulus, I is a polar second moment of area parameter, B is a second derivative of a shape function, B^{T} is a transpose of the second derivative of the shape function, N is the shape function, N^{T} is a transpose of the shape function, q is an external load, x is a structural longitudinal position parameter, and L is a longitudinal length of a bridge structure.

In some embodiments, a method for obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information is as follows:
S21: acquiring the vehicle positions and the number plate information;
S22: acquiring the axle load-number plate information;
S23: obtaining a number plate, an axle load, position information, and time information of each vehicle through the annotation information, and jointly constructing axle load position distribution information with a time course of vehicles crossing a deck as the vehicle load information;
S24: collecting the environment load information of the bridge including the temperature, humidity, and wind speed and direction information of the bridge in real time by using a temperature and humidity sensor and a wind speed and direction sensor at a front end, and jointly constructing environment load information of the bridge changing with time as the environment load information; and
S25: matching the vehicle load information and the environment load information through the time information included therein as the vehicle-environment load information.

In some embodiments, a method for acquiring the vehicle positions and the number plate information includes the following steps:
S211: arranging video collection devices on the bridge, and covering video information collection of all lanes on the deck;
S212: for each frame of video image collected by the video collection devices, recognizing number plate information and model information of vehicles on the bridge in real time by using a target recognition deep learning algorithm, where the number plate information is used as annotation information of the vehicles;
S213: dividing, according to a lane direction and a lane normal direction, a collection area into a longitudinal position and a transverse position that are represented as x and y respectively to construct a lane coordinate system;
S214: representing the transverse position and the longitudinal position in the video image by Ox and Oy to construct an image coordinate system;
S215: performing conversion on the lane coordinate system and the image coordinate system through a position relationship between a camera and a lane by using a space coordinate conversion equation:

$$\begin{matrix}x = Ox \cdot cos θ - Oy \cdot sin θ \\ y = Ox \cdot sin θ + Oy \cdot cos θ\end{matrix} ;$$

and
wherein θ represents a rotation angle;
S216: for a vehicle appearing in a video collection area, determining a position of the vehicle in a picture according to a position of a vehicle head center to obtain a position, i.e., an actual position information, of the vehicle in the lane coordinate system, and simultaneously acquiring time information of collecting each frame of image by the camera, where the position and the time information of each vehicle are differentiated through the number plate.

In some embodiments, a method for acquiring the axle load-number plate information is: paving a lane-level dynamic weighing system on each lane at a front-end position of the bridge; and collecting a number plate and axle load information of a vehicle by using a camera and a weighing device in the dynamic weighing system, where the number plate is used as annotation information, and the axle load information of each vehicle is differentiated through the number plate.

In some embodiments, a method for adaptively training a finite element pilot-based deep learning neural network proxy model includes the following steps:
S31: initializing parameters of a model: defining, according to requirements of a quantity of input variables of the model, a scale of the bridge finite element model, and a quantity of output variables, a network structure of a deep learning neural network, including quantities of input and output neurons, a quantity of layers of the neural network, and a quantity of neurons of each layer;
S32: constructing a data set: inputting collected vehicle-environment load information data of one day as a data set a into the model; inputting collected vehicle-environment load information data of ten days as a data set b into the model; and scrambling a data structure of collected vehicle-environment load information data of three days, and inputting the scrambled data as a test set into the model;
S33: defining loss functions:
a loss function for increasing a finite element domain:

$${L}_{total} = {w}_{data} {L}_{data} + {w}_{Energy} {L}_{Energy} ,$$

wherein Lₜₒₜₐₗ is a total loss function comprising data and potential energy, L_{data} is a data-based loss function, w_{data} is a weight coefficient corresponding to the data-based loss function, L_{Energy} is a potential energy-based loss function, and w_{Energy} is a weight coefficient corresponding to the potential energy-based loss function;
the data-based loss function is as follows:

$${L}_{data} = \frac{1}{Nm} {\sum }_{i = 0}^{Nm} {\vert {u}^{i} - {\hat{u}}^{i} \vert}^{2} ,$$

wherein Nm is a total number of data points, i is an index configured for iterating over each data point during a summation process, uⁱ a true value of an i-th data point, and ûⁱ is a predicted value of the i-th data point; and
the potential energy-based loss function is as follows:

$${L}_{Energy} = \frac{1}{2} {\int }_{0}^{L} EI {κ}^{2} dx - {\int }_{0}^{L} qv dx ,$$

wherein k is a curvature of the bridge structure, v is a velocity of the bridge structure, and x is an integration variable configured for indicating a position of a point of the bridge structure along a length of the bridge structure;
S34: defining an optimization algorithm by using a quasi-Newton method in a second-order optimization method;
S35: iteratively training the model: inputting the data set a and the data set b into the two loss functions L_{data} and L_{Energy} respectively to perform adaptive iterative training to make loss values lower than an allowable value, setting the allowable value to 0.00001, automatically stopping training when the allowable value is reached, and outputting the finite element pilot-based deep learning neural network proxy model; and
S36: inputting the data of the test set into the model for training to obtain the finite element pilot-based deep learning neural network proxy model, and evaluating accuracy of the finite element pilot-based deep learning neural network proxy model, where a manner of evaluation is manually checking a part of data, when checked data reaches 99.5% of simulated precision, the model is successfully trained, or otherwise the process returns to S35 to iteratively train the model again, and the allowable value is turned down by 10% until a precision requirement is met.

In some embodiments, a method for inputting the vehicle-environment load information into a finite element pilot-based deep learning neural network proxy model, calculating data through the model, and outputting a real-time structural state of running of the bridge includes the following steps:
S41: inputting the vehicle-environment load information into the finite element pilot-based deep learning neural network proxy model for calculation, i.e., performing superimposed calculation by using trained neurons, and calculating output parameters, where the output parameters are response parameters of the bridge structure, and the response parameters include deflection, stress, and strain parameters at critical positions of the bridge; and
S42: acquiring maximum deflection o in the response parameters of the bridge structure;
performing calculation according to a regulation of a deflection limit value in bridge design specifications, as follows:

$${ω}_{limit} = \frac{1}{600} {η}_{θ} \cdot L ,$$

where ωₗᵢₘᵢₜ represents the deflection limit value, η_{θ} represents a deflection long-term increase coefficient, and L represents a structural length of the bridge; and
evaluating a bridge state according to a ratio of the maximum deflection of the bridge to the deflection limit value:

$${η}_{w} = \frac{ω}{{ω}_{limit}} ,$$

where η_{w} represents a bridge state value; when η_{w} ranges from 0.5 to 0.8, the bridge state is a safe state; when η_{w} ranges from 0.8 to 1.0, the bridge is in an imminent-danger state; and when η_{w} is greater than 1, the bridge state is a danger state.

Solution 2: An electronic device includes a memory and a processor, where the memory stores a computer program; and the processor, when executing the computer program, implements the steps of the method for evaluating the running state of the bridge using the finite element pilot-based deep learning proxy model in Solution 1.

Solution 3: A computer-readable storage medium has a computer program stored thereon, where the computer program, when being executed by a processor, implements the method for evaluating the running state of the bridge using the finite element pilot-based deep learning proxy model in Solution 1.

Beneficial effects of this application are as follows: a finite element pilot-based deep learning proxy model established in this application implements real-time online simulation of the bridge state in an actual environment and a vehicle load, and simulation may reach a millisecond level, to implement for real real-time diagnosis of the bridge state.

### BRIEF DESCRIPTION OF DRAWINGS

The accompanying drawings described herein are used to provide a further understanding of this application, and constitute a part of this application. The schematic embodiments of this application and the description thereof are used to described this application and do not constitute an inappropriate limitation to this application. In the accompanying drawings:

FIG. 1 is a schematic flowchart of a method for evaluating a running state of a bridge using a finite element pilot-based deep learning proxy model.

### DETAILED DESCRIPTION

To make the technical solutions and advantages in the embodiments of this application clearer, exemplary embodiments of this application are further described below in detail with reference to the accompanying drawings. Apparently, the described embodiments are merely some rather than all of the embodiments of this application. It should be noted that the embodiments in this application and the features in the embodiments may be combined with each other without causing any conflict.

### Embodiment 1

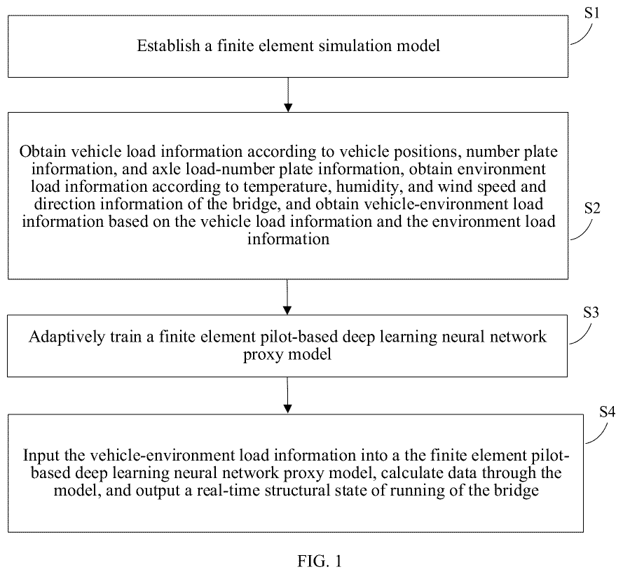

This implementation is described with reference to FIG. 1. A real-time online bridge simulation method includes the following steps:
S1: establishing a finite element simulation model.
S11: obtaining bridge structure sizes and material type parameters on a bridge design drawing.
S12: establishing a bridge finite element model including structural geometry and material information by using a finite element method,

$$Π = \frac{1}{2} {u}^{T} {\int }_{0}^{L} {EIB}^{T} Bdxu - {u}^{T} {\int }_{0}^{L} {N}^{T} qdx ,$$

where u is a structural response displacement parameter, u_{T} is a transpose of the structural response displacement parameter, E is a structural elastic modulus, I is a polar second moment of area parameter, B is a second derivative of a shape function, B_{T} is a transpose of the second derivative of the shape function, N is the shape function, N_{T} is a transpose of the shape function, q is an external load, x is a structural longitudinal position parameter, and L is a longitudinal length of a bridge structure.
S2: obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information.
S21: acquiring the vehicle positions and the number plate information.
S211: arranging video collection devices on the bridge, covering video information collection of all lanes on the deck.
S212: for each frame of video image collected by the video collection devices, recognizing number plate information and model information of vehicles on the bridge in real time by using a target recognition deep learning algorithm, where the number plate information is used as annotation information of the vehicles.
S213: dividing, according to a lane direction and a lane normal direction, a collection area into a longitudinal position and a transverse position that are represented as x and y respectively to construct a lane coordinate system, where the collection area of each video collection device is fixed.
S214: because a position of a camera does not necessarily match transverse and longitudinal positions of a lane, representing the transverse position and the longitudinal position in the video image by Ox and Oy to construct an image coordinate system.
S215: performing conversion on the lane coordinate system and the image coordinate system through a position relationship between a camera and a lane by using a space coordinate conversion equation:

$$x = Ox \cdot cos θ - Oy \cdot sin θ \\ y = Ox \cdot sin θ + Oy \cdot cos θ ;$$

wherein θ represents a rotation angle.
S216: for a vehicle appearing in a video collection area, determining a position of the vehicle in a picture according to a position of a vehicle head center to obtain a position, i.e., an actual position information, of the vehicle in the lane coordinate system, and simultaneously acquiring time information of collecting each frame of image by the camera, where the position and the time information of each vehicle are differentiated through the number plate.
S22: acquiring the axle load-number plate information.
S221: paving a lane-level dynamic weighing system on each lane at a front-end position of the bridge; and collecting a number plate and axle load information of a vehicle by using a camera and a weighing device in the dynamic weighing system, where the number plate is used as annotation information, and the axle load information of each vehicle is differentiated through the number plate.
S23: obtaining a number plate, an axle load, position information, and time information of each vehicle through the annotation information, and jointly constructing axle load position distribution information with a time course of vehicles crossing a deck as the vehicle load information.
S24: collecting the environment load information of the bridge including the temperature, humidity, and wind speed and direction information of the bridge in real time by using a temperature and humidity sensor and a wind speed and direction sensor at a front end, and jointly constructing environment load information of the bridge changing with time as the environment load information.
S25: matching the vehicle load information and the environment load information through the time information included therein as the vehicle-environment load information.
S3: adaptively training a finite element pilot-based deep learning neural network proxy model.
S31: initializing parameters of a model: defining, according to requirements of a quantity of input variables of the model, a scale of the bridge finite element model, and a quantity of output variables, a network structure of a deep learning neural network, including quantities of input and output neurons, a quantity of layers of the neural network, and a quantity of neurons of each layer.
S32: constructing a data set: inputting collected vehicle-environment load information data of one day as a data set a into the model; inputting collected vehicle-environment load information data of ten days as a data set b into the model; and scrambling a data structure of collected vehicle-environment load information data of three days, and inputting the scrambled data as a test set into the model.
S33: defining loss functions:
a loss function for increasing a finite element domain:

$${L}_{total} = {w}_{data} {L}_{data} + {w}_{Energy} {L}_{Energy} ,$$

wherein Lₜₒₜₐₗ is a total loss function comprising data and potential energy, L_{data} is a data-based loss function, w_{data} is a weight coefficient corresponding to the data-based loss function, L_{Energy} is a potential energy-based loss function, and w_{Energy} is a weight coefficient corresponding to the potential energy-based loss function;
the data-based loss function is as follows:

$${L}_{data} = \frac{1}{Nm} {\sum }_{i = 0}^{Nm} {\vert {u}^{i} - {\hat{u}}^{i} \vert}^{2} ,$$

wherein Nm is a total number of data points, i is an index configured for iterating over each data point during a summation process, uⁱ is a true value of an i-th data point, and ûᵢ is a predicted value of the i-th data point; and
the potential energy-based loss function is as follows:

$${L}_{Energy} = \frac{1}{2} {\int }_{0}^{L} EI {κ}^{2} dx - {\int }_{0}^{L} qvdx ;$$

wherein k is a curvature of the bridge structure, v is a velocity of the bridge structure, and x is an integration variable configured for indicating a position of a point of the bridge structure along a length of the bridge structure.
S34: defining an optimization algorithm by using a quasi-Newton method in a second-order optimization method.
S35: iteratively training the model: inputting the data set a and the data set b into the two loss functions L_{data} and L_{Energy} respectively to perform adaptive iterative training to make loss values lower than an allowable value, setting the allowable value to 0.00001, automatically stopping training when the allowable value is reached, and outputting the finite element pilot-based deep learning neural network proxy model.

S36: inputting the data of the test set into the model for training to obtain the finite element pilot-based deep learning neural network proxy model, and evaluating accuracy of the finite element pilot-based deep learning neural network proxy model, where a manner of evaluation is manually checking a part of data, when checked data reaches 99.5% of simulated precision, the model is successfully trained, or otherwise the process returns to S35 to iteratively train the model again, and the allowable value is turned down by 10% until a precision requirement is met.
S4: inputting the vehicle-environment load information into the finite element pilot-based deep learning neural network proxy model, calculating data through the model, and outputting a real-time structural state of running of the bridge.
S41: inputting the vehicle-environment load information into the finite element pilot-based deep learning neural network proxy model for calculation, i.e., performing superimposed calculation by using trained neurons, and calculating output parameters, where the output parameters are response parameters of the bridge structure, and the response parameters include deflection, stress, and strain parameters at critical positions of the bridge.
S42: acquiring maximum deflection ω in the response parameters of the bridge structure;
performing calculation according to a regulation of a deflection limit value in bridge design specifications, as follows:

$${ω}_{limit} = \frac{1}{600} {η}_{θ} \cdot L ,$$

where ωlimit represents the deflection limit value, η_{θ} represents a deflection long-term increase coefficient, and L represents a structural length of the bridge; and
evaluating a bridge state according to a ratio of the maximum deflection of the bridge to the deflection limit value:

$${η}_{w} = \frac{ω}{{ω}_{limit}} ,$$

where η_{w} represents a bridge state value; when η_{w} ranges from 0.5 to 0.8, the bridge state is a safe state; when η_{w} ranges from 0.8 to 1.0, the bridge is in an imminent-danger state; and when η_{w} is greater than 1, the bridge state is a danger state.

### Embodiment 2

A computer device in this application may be an apparatus including a processor, a memory, and the like, for example, a single-chip microcomputer including a central processing unit. In addition, the processor is configured to implement, when executing a computer program stored in the memory, the steps of the foregoing method for evaluating the running state of the bridge using the finite element pilot-based deep learning proxy model.

The processor may be a central processing unit (CPU), or may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The storage may mainly include a program storage area and a data storage area. The program storage area may store an operating system, an application required for at least one function (for example, a sound playing function, an image playing function, etc.), and the like. The data storage area may store data (for example, audio data, a phone book, etc.) created according to the use of a mobile phone. In addition, the memory may include a high-speed random-access memory, or may include a non-volatile memory, for example, a hard disk, an internal memory, a plug-in hard disk, a smart media card (SMC), a secure digital (SD) card, a flash card, at least one disk storage device, a flash memory device, or anther volatile solid-state storage device.

### Embodiment 3

Embodiment of computer-readable storage medium.

The computer-readable storage medium in this application may be any form of storage medium read by a processor of a computer device, and includes, but is not limited to, a non-volatile memory, a volatile memory, a ferroelectric memory, etc. The computer-readable storage medium stores a computer program. The processor of the computer device may implement, when reading and executing the computer program stored in the memory, the steps of the foregoing method for evaluating the running state of the bridge using the finite element pilot-based deep learning proxy model.

The computer program includes a computer program code. The computer program code may be in the form of a source code, in the form of an object code, in the form of an executable file, in some intermediate forms, or the like. The computer-readable medium may include: any entity or apparatus capable of carrying the computer program code, a recording medium, a USB flash drive, a removable hard drive, a disk, an optical disc, a computer memory, a read-only memory (ROM), a random-access memory (RAM), an electrical carrier signal, a telecommunication signal, and a software distribution medium, or the like. It should be noted that the content contained in the computer-readable medium may be added or omitted as appropriate according to the requirements of legislation and patent practice in the jurisdiction. For example, in some jurisdictions, according to legislation and patent practice, the computer-readable medium does not include the electric carrier signal and the telecommunication signal.

Although this application has been described in accordance with a limited number of embodiments, with the benefit of the foregoing description, a person skilled in the art understands that other embodiments may be envisioned within the scope of this application as thus described. Furthermore, it should be noted that the language used in this specification has been chosen primarily for readability and instructional purposes, and not to explain or limit the subject matter of this application. Therefore, many modifications and changes are apparent to those of ordinary skill in the art without departing from the scope and spirit of the appended claims. With respect to the scope of this application, the disclosure made in this application is illustrative and not limiting, and the scope of this application is limited by the appended claims.

What is claimed is:

1. A method for evaluating a running state of a bridge using a finite element pilot-based deep learning proxy model, comprising the following operations:
S1: establishing a finite element simulation model;
S2: obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information;
S3: adaptively training a finite element pilot-based deep learning neural network proxy model; and
S4: inputting the vehicle-environment load information into the finite element pilot-based deep learning neural network proxy model, calculating data through the model, and outputting a real-time structural state of running of the bridge.

2. The method for evaluating the running state of the bridge using the finite element pilot-based deep learning proxy model according to claim 1, wherein the operation of establishing a finite element simulation model comprises:
S11: acquiring bridge structure sizes and material type parameters on a bridge design drawing; and
S12: establishing a bridge finite element model comprising structural geometry and material information by using a finite element method,
$$Π = \frac{1}{2} {u}^{T} {\int }_{0}^{L} {EIB}^{T} Bdxu - {u}^{T} {\int }_{0}^{L} {N}^{T} qdx ,$$
wherein u is a structural response displacement parameter, u^{T} is a transpose of the structural response displacement parameter, E is a structural elastic modulus, I is a polar second moment of area parameter, B is a second derivative of a shape function, B^{T} is a transpose of the second derivative of the shape function, N is the shape function, N^{T} is a transpose of the shape function, q is an external load, x is a structural longitudinal position parameter, and L is a longitudinal length of a bridge structure.

3. The method for evaluating the running state of the bridge using the finite element pilot-based deep learning proxy model according to claim 2, wherein the operation of obtaining vehicle load information according to vehicle positions, number plate information, and axle load-number plate information, obtaining environment load information according to temperature, humidity, and wind speed and direction information of the bridge, and obtaining vehicle-environment load information based on the vehicle load information and the environment load information comprises:
S21: acquiring the vehicle positions and the number plate information;
S22: acquiring the axle load-number plate information;
S23: obtaining a number plate, an axle load, position information, and time information of each vehicle through annotation information, and jointly constructing axle load position distribution information with a time course of vehicles crossing a deck as the vehicle load information;
S24: collecting the environment load information of the bridge comprising the temperature, humidity, and wind speed and direction information of the bridge in real time by using a temperature and humidity sensor and a wind speed and direction sensor at a front end, and jointly constructing environment load information of the bridge changing with time as the environment load information; and
S25: matching the vehicle load information and the environment load information through the time information comprised therein as the vehicle-environment load information.

4. The method for evaluating the running state of the bridge using the finite element pilot-based deep learning proxy model according to claim 3, wherein the operation of obtaining the vehicle positions and the number plate information comprises:
S211: arranging video collection devices on the bridge, covering video information collection of all lanes on the deck;
S212: for each frame of video image collected by the video collection devices, recognizing number plate information and model information of vehicles on the bridge in real time by using a target recognition deep learning algorithm, wherein the number plate information is used as annotation information of the vehicles;
S213: dividing, according to a lane direction and a lane normal direction, a collection area into a longitudinal position and a transverse position that are represented as x and y respectively to construct a lane coordinate system;
S214: representing the transverse position and the longitudinal position in the video image by Ox and Oy to construct an image coordinate system;
S215: performing conversion on the lane coordinate system and the image coordinate system through a position relationship between a camera and a lane by using a space coordinate conversion equation:
$$x = Ox \cdot cos θ - Oy \cdot sin θ \\ y = Ox \cdot sin θ + Oy \cdot cos θ ;$$
and
wherein θ represents a rotation angle;
S216: for a vehicle appearing in a video collection area, determining a position of the vehicle in a picture according to a position of a vehicle head center to obtain a position, i.e., an actual position information, of the vehicle in the lane coordinate system, and simultaneously acquiring time information of collecting each frame of image by the camera, wherein the position and the time information of each vehicle are differentiated through the number plate.

5. The method for evaluating the running state of the bridge using the finite element pilot-based deep learning proxy model according to claim 4, wherein the operation of acquiring the axle load-number plate information comprises: paving a lane-level dynamic weighing system on each lane at a front-end position of the bridge; and collecting a number plate and axle load information of a vehicle by using a camera and a weighing device in the dynamic weighing system, wherein the number plate is used as annotation information, and the axle load information of each vehicle is differentiated through the number plate.

6. The method for evaluating the running state of the bridge using the finite element pilot-based deep learning proxy model according to claim 5, wherein the operation of adaptively training a finite element pilot-based deep learning neural network proxy model comprises:
S31: initializing parameters of a model: defining, according to requirements of a quantity of input variables of the model, a scale of the bridge finite element model, and a quantity of output variables, a network structure of a deep learning neural network, comprising quantities of input and output neurons, a quantity of layers of the neural network, and a quantity of neurons of each layer;
S32: constructing a data set: inputting collected vehicle-environment load information data of one day as a data set a into the model; inputting collected vehicle-environment load information data of ten days as a data set b into the model; and scrambling a data structure of collected vehicle-environment load information data of three days, and inputting the scrambled data as a test set into the model;
S33: defining loss functions:
a loss function for increasing a finite element domain:
$${L}_{total} = {w}_{data} {L}_{data} + {w}_{Energy} {L}_{Energy} ,$$
wherein Lₜₒₜₐₗ is a total loss function comprising data and potential energy, L_{data} is a data-based loss function, w_{data} is a weight coefficient corresponding to the data-based loss function, L_{Energy} is a potential energy-based loss function, and w_{Energy} is a weight coefficient corresponding to the potential energy-based loss function;
the data-based loss function is as follows:
$${L}_{data} = \frac{1}{Nm} {\sum }_{i = 0}^{Nm} {\vert {u}^{i} - {\hat{u}}^{i} \vert}^{2} ,$$
wherein Nm is a total number of data points, i is an index configured for iterating over each data point during a summation process, uᵢ is a true value of an i-th data point, and ûᵢ is a predicted value of the i-th data point; and
the potential energy-based loss function is as follows:
$${L}_{Energy} = \frac{1}{2} {\int }_{0}^{L} EI {κ}^{2} dx - {\int }_{0}^{L} qvdx ,$$
wherein k is a curvature of the bridge structure, v is a velocity of the bridge structure, and x is an integration variable configured for indicating a position of a point of the bridge structure along a length of the bridge structure;
S34: defining an optimization algorithm by using a quasi-Newton method in a second-order optimization method;
S35: iteratively training the model: inputting the data set a and the data set b into the two loss functions L_{data} and L_{Energy} respectively to perform adaptive iterative training to make loss values lower than an allowable value, setting the allowable value to 0.00001, automatically stopping training when the allowable value is reached, and outputting the finite element pilot-based deep learning neural network proxy model; and
S36: inputting the data of the test set into the model for training to obtain the finite element pilot-based deep learning neural network proxy model, and evaluating accuracy of the finite element pilot-based deep learning neural network proxy model, wherein a manner of evaluation is manually checking a part of data, when checked data reaches 99.5% of simulated precision, the model is successfully trained, or otherwise the process returns to S35 to iteratively train the model again, and the allowable value is turned down by 10% until a precision requirement is met.

7. The method for evaluating the running state of the bridge using the finite element pilot-based deep learning proxy model according to claim 6, wherein the operation of inputting the vehicle-environment load information into a finite element pilot-based deep learning neural network proxy model, calculating data through the model, and outputting a real-time structural state of running of the bridge comprises:
S41: inputting the vehicle-environment load information into the finite element pilot-based deep learning neural network proxy model for calculation, i.e., performing superimposed calculation by using trained neurons, and calculating output parameters, wherein the output parameters are response parameters of the bridge structure, and the response parameters comprise deflection, stress, and strain parameters at critical positions of the bridge; and
S42: acquiring maximum deflection ω in the response parameters of the bridge structure;
performing calculation according to a regulation of a deflection limit value in bridge design specifications, as follows:
$${ω}_{limit} = \frac{1}{600} {η}_{θ} \cdot L ,$$
wherein ωₗᵢₘᵢₜ represents the deflection limit value, η_{θ} represents a deflection long-term increase coefficient, and L represents a structural length of the bridge; and
evaluating a bridge state according to a ratio of the maximum deflection of the bridge to the deflection limit value:
$${η}_{w} = \frac{ω}{{ω}_{limit}} ,$$
wherein η_{w} represents a bridge state value; when η_{w} ranges from 0.5 to 0.8, the bridge state is a safe state; when η_{w} ranges from 0.8 to 1.0, the bridge is in an imminent-danger state; and when η_{w} is greater than 1, the bridge state is a danger state.

8. An electronic device, comprising a memory and a processor, wherein the memory stores a computer program; and the processor, when executing the computer program, implements the steps of the method for evaluating the running state of the bridge using the finite element pilot-based deep learning proxy model according to claim 1.

9. A computer-readable storage medium, having a computer program stored thereon, wherein the computer program, when being executed by a processor, implements the method for evaluating the running state of the bridge using the finite element pilot-based deep learning proxy model according to claim 1.
